(19) United States
(12) Patent Application Publication
(10) Pub. No.: US 2024/0304873 A1
(43) Pub. Date: Sep. 12, 2024

(54) METHOD FOR MANUFACTURING ELECTRODE ASSEMBLY AND ELECTRODE ASSEMBLY MANUFACTURED BY THE METHOD

(71) Applicant: SAMSUNG SDI CO., LTD., Yongin-si (KR)

(72) Inventor: In Seop BYUN, Yongin-si (KR)

(21) Appl. No.: 18/238,645

(22) Filed: Aug. 28, 2023

(30) Foreign Application Priority Data
Mar. 10, 2023 (KR) 10-2023-0031622

(51) Int. Cl. H01M 10/42; H01M 4/04; H01M 10/04

(52) U.S. Cl. CPC H01M 10/4235; H01M 4/0416; H01M 4/0471; H01M 10/0431

(57) ABSTRACT

A method for manufacturing an electrode assembly and an electrode assembly prepared according to the method, the method including preparing an electrode assembly body; preparing a binder solution in a storage tank; impregnating a first region of one end of the electrode assembly body with the binder solution; and drying the binder solution applied to the electrode assembly body.

### CROSS-REFERENCE TO RELATED APPLICATION

This application claims priority to and the benefit of Korean Patent Application No. 10-2023-0031622 filed on Mar. 10, 2023, in the Korean Intellectual Property Office, the entire disclosure of which is incorporated herein by reference.

### BACKGROUND

### 1. Field

Embodiments relate to a method for manufacturing an electrode assembly and an electrode assembly manufactured by the method.

### 2. Description of the Related Art

Unlike primary batteries that cannot be recharged, secondary batteries are batteries that can be charged and discharged. Low-capacity batteries may be used in portable small electronic devices such as mobile phones and camcorders, and large-capacity batteries may be used as power sources for driving motors in hybrid vehicles and electric vehicles.

An electrode assembly used in a secondary battery may include a negative electrode plate, a positive electrode plate, and a separator between the negative electrode plate and the positive electrode plate to help prevent a short circuit therebetween.

### SUMMARY

The embodiments may be realized by providing a method for manufacturing an electrode assembly, the method including preparing an electrode assembly body; preparing a binder solution in a storage tank; impregnating a first region of one end of the electrode assembly body with the binder solution; and drying the binder solution applied to the electrode assembly body.

The method may further include impregnating a second region of the one end of the electrode assembly body with the binder solution after impregnating the first region of the one end of the electrode assembly body with the binder solution.

The method may further include an additional dipping step of impregnating the one end of the electrode assembly body with the binder solution after impregnating the second region if there is another region of the one end of the electrode assembly body where the binder solution has not been applied.

Impregnating the first region of the one end of the electrode assembly body with the binder solution may include tilting the electrode assembly body with respect to a surface of the binder solution.

Impregnating the first region of the one end of the electrode assembly body with the binder solution may include simultaneously applying the binder solution to an end surface of the one end of the electrode assembly body and a side surface of the one end of the electrode assembly body that is adjacent to the end surface of the one end of the electrode assembly body.

The electrode assembly body may include a negative electrode plate, a positive electrode plate, and a separator, and impregnating the first region of the one end of the electrode assembly body with the binder solution may include applying the binder solution to at least respective outermost layers of the negative electrode plate, the positive electrode plate, and the separator.

Impregnating the first region of the one end of the electrode assembly body with the binder solution may include applying the binder solution only to an outer edge of the one end of the electrode assembly body, and not applying the binder solution to a central portion of the one end of the electrode assembly body.

The embodiments may be realized by providing an electrode assembly including a negative electrode plate; a positive electrode plate; a separator; and a binder layer, the binder layer being along an edge of one end of the electrode assembly.

The binder layer may extend as a whole along the edge of the one end.

The binder layer may continuously or integrally extend across an end surface of the one end and a side surface adjacent to the end surface of the one end.

A thickness of the binder layer on the negative electrode plate, the positive electrode plate, and the separator, may be greatest at an outermost part of the electrode assembly and is gradually reduced toward an interior of the electrode assembly.

The binder layer may be on at least respective outermost layers of the negative electrode plate, the positive electrode plate, and the separator.

The binder layer may only be on an outer edge of an end surface of the one end, and may not be on a central portion of the end surface of the one end.

### BRIEF DESCRIPTION OF DRAWINGS

Features will be apparent to those of skill in the art by describing in detail exemplary embodiments with reference to the attached drawings in which:

FIG. 1 is a flowchart of a method for manufacturing an electrode assembly according to an embodiment of the present disclosure.

FIG. 2 is a schematic diagram illustrating an electrode assembly body preparation step in the method for manufacturing an electrode assembly according to an embodiment of the present disclosure.

FIG. 3 is a schematic diagram showing a binder solution preparation step in the method for manufacturing an electrode assembly according to an embodiment of the present disclosure.

FIG. 4 is a schematic diagram illustrating a first dipping step in the method for manufacturing an electrode assembly according to an embodiment of the present disclosure.

FIG. 5 is a cross-sectional view showing a first dipping step in the method for manufacturing an electrode assembly according to an embodiment of the present disclosure, showing a state in which the electrode assembly body is impregnated with a binder solution.

FIG. 6 is a schematic diagram illustrating a second dipping step in the method for manufacturing an electrode assembly according to an embodiment of the present disclosure.

FIG. 7 is a schematic diagram of an electrode assembly manufactured by the method for manufacturing an electrode assembly according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the terms “or” and “and/or” are not exclusive terms, and include any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

As used herein, the singular forms are intended to include the plural forms as well, unless the context clearly indicates otherwise. It will be further understood that the terms that the terms “comprise,” “include,” “comprising,” or “including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections are not be limited by these terms, and these terms are not intended to imply or require sequential inclusion. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

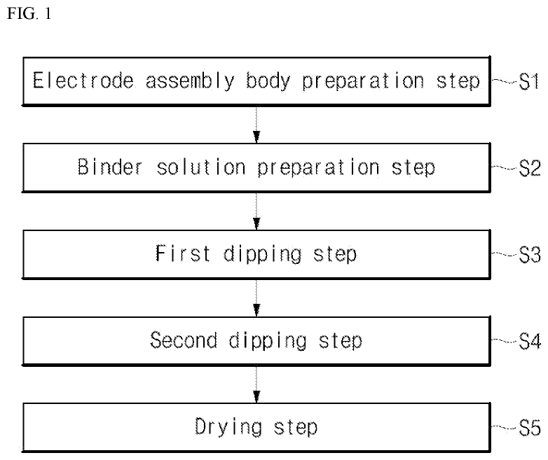

FIG. 1 is a flowchart of a method for manufacturing an electrode assembly according to an embodiment of the present disclosure.

Referring to FIG. 1, the electrode assembly manufacturing method according to the embodiment of the present disclosure may include, e.g., an electrode assembly body preparation step (S1), a binder solution preparation step (S2), a first dipping step (S3), a second dipping step (S4), and a drying step (S5).

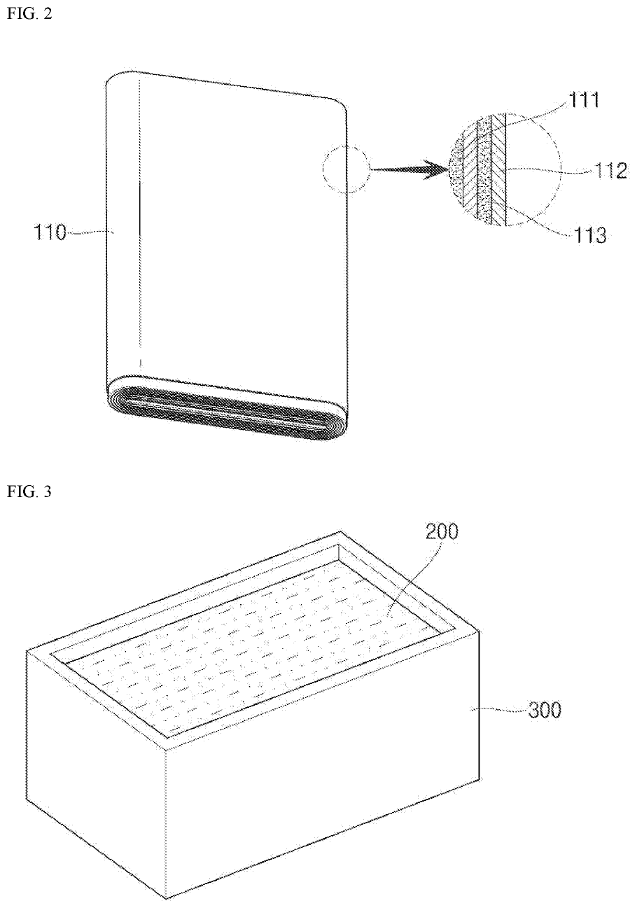

FIG. 2 is a schematic diagram illustrating an electrode assembly body preparation step (S1) in the method for manufacturing an electrode assembly according to an embodiment of the present disclosure.

Referring to FIG. 2, in the electrode assembly body preparation step (S1), an electrode assembly body 110 may be prepared.

The electrode assembly body 110 may include a negative electrode plate 111, a positive electrode plate 112, and a separator 113.

The negative electrode plate 111 may include a negative electrode coated portion that is coated with a negative electrode active material, and a negative electrode uncoated portion that is not coated with a negative electrode active material, on a negative electrode current collector plate made of a thin conductive metal plate, e.g., copper or nickel foil or mesh. In an implementation, the negative electrode active material may include, e.g., a carbon material, Si, Sn, tin oxide, a tin alloy composite, a transition metal oxide, lithium metal nitrite, or another metal oxide.

The positive electrode plate 112 may include a positive electrode coated portion that is coated with a positive electrode active material and a positive electrode uncoated portion that is not coated with a positive electrode active material, on a positive electrode current collector plate made of a thin conductive metal plate, e.g., aluminum foil or mesh. In an implementation, the positive electrode active material may be include a chalcogenide compound, e.g., a complex metal oxide such as LiCoO₂, LiMn₂O₄, LiNiO₂, or LiNiMnO₂.

The separator 113 may be between the negative electrode plate 111 and the positive electrode plate 112 to help prevent a short circuit between the negative electrode plate 111 and the positive electrode plate 112. In an implementation, the separator 113 may be made of, e.g., polyethylene, polypropylene, or a porous copolymer of polyethylene and polypropylene.

In the electrode assembly body 110, the negative electrode plate 111, the positive electrode plate 112, and the separator 113 may be elongate in one direction, and the electrode assembly body 110 may be formed by winding together the negative electrode plate 111, the separator 113, the positive electrode plate 112, and the separator 113, in a state of being stacked in that order (e.g., a winding type). In an implementation, in the electrode assembly body 110, the negative electrode plate 111, the positive electrode plate 112, and the separator 113 may be formed to have a shape corresponding to the desired electrode assembly body 110, and the electrode assembly body 110 may be formed by repeatedly stacking the negative electrode plate 111, the separator 113, the positive electrode plate 112, and the separator 113 in that order (e.g., a stacking type). In the drawings, the winding type is illustrated.

FIG. 3 is a schematic diagram showing a binder solution preparation step (S2) in the method for manufacturing an electrode assembly according to an embodiment of the present disclosure.

Referring to FIG. 3, in the binder solution preparation step (S2), a binder solution 200 may be prepared in a storage tank 300.

The binder solution 200 may have a viscosity of, e.g., 15,000 cps or less at a temperature of 23-100° C., to be suitable for dipping. In an implementation, the binder solution 200 may include, e.g., hot melts such as PP and styrene, acrylates containing a UV photoinitiator as additives, a mixture of acrylates and urethane, epoxy, or the like.

In an implementation, the electrode assembly body preparation step (S1) may be followed by the binder solution preparation step (S2). In an implementation, depending on circumstances, the electrode assembly body preparation step (S1) may be performed after the binder solution preparation step (S2), or the electrode assembly body preparation step (S1) and the binder solution preparation step (S2) may be performed simultaneously.

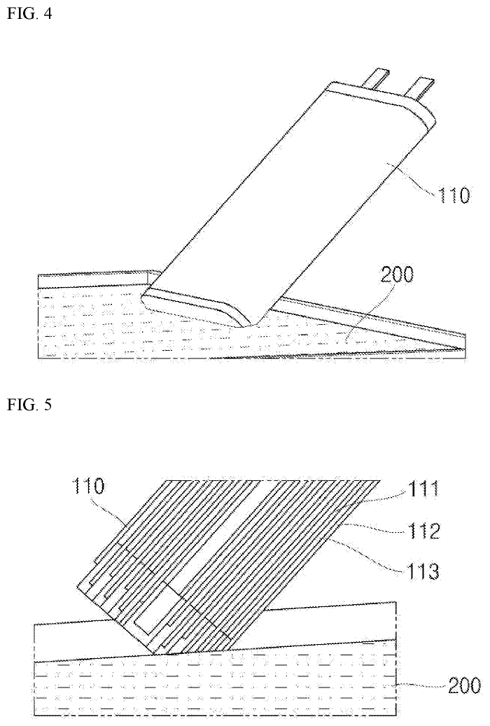

FIG. 4 is a schematic diagram illustrating a first dipping step (S3) in the method for manufacturing an electrode assembly according to an embodiment of the present disclosure, and FIG. 5 shows a state in which the electrode assembly 100 is impregnated with the binder solution 200.

Referring to FIGS. 4 and 5, in the first dipping step (S3), a portion of an edge of one end of the electrode assembly body 110 may be dipped into and impregnated with the binder solution 200. In an implementation, as illustrated in the drawing, a straight section of the edge of the electrode assembly body 110 may be impregnated with the binder solution 200.

In an implementation, in the first dipping step (S3), the electrode assembly body 110 may be tilted obliquely with respect to the surface of the binder solution 200, and the end surface of the one end of the electrode assembly body 110 (e.g., the lower surface of the electrode assembly body 110) and the side surface adjacent thereto may be simultaneously impregnated with the binder solution 200.

In an implementation, in relation to the depth or angle at which the electrode assembly body 110 is impregnated with the binder solution 200, the negative electrode plate 111, the positive electrode plate 112, and the separator 113, at least located outermost, may be dipped to such an extent that the binder solution 200 may be applied thereto, respectively.

In an implementation, the electrode assembly body 110 may be dipped so that the binder solution 200 is applied only to the edge of the end surface of the one end of the electrode assembly body 110 and is not applied to the central portion of the end surface of the one end of the electrode assembly body 110.

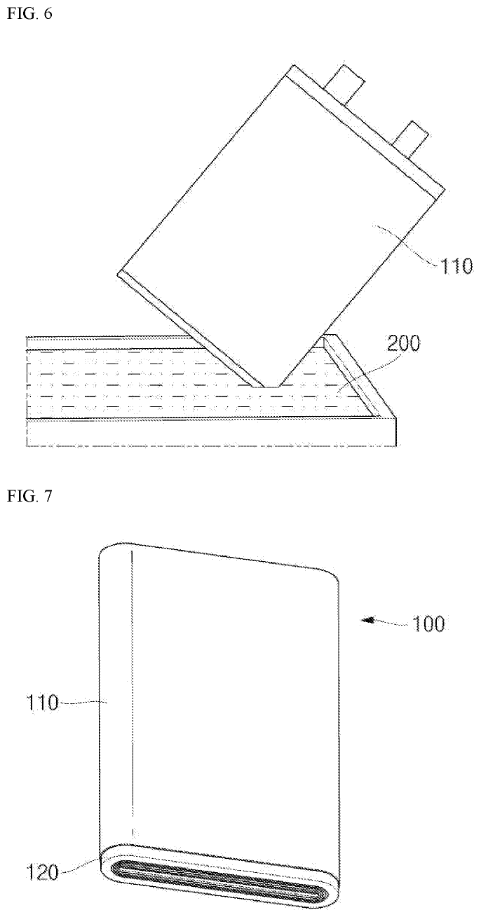

FIG. 6 is a schematic diagram illustrating a second dipping step (S4) in the method for manufacturing an electrode assembly according to an embodiment of the present disclosure.

Referring to FIG. 6, in the second dipping step (S4), another portion of the edge of the one end of the electrode assembly body 110 may be dipped into and impregnated with the binder solution 200. In an implementation, as illustrated in the drawing, the curved section of the lower edge of the electrode assembly body 110 may be impregnated with the binder solution 200.

Similarly to the first dipping step (S3), in the second dipping step (S4), by tilting the electrode assembly body 110 with respect to the surface of the binder solution 200, the end surface of the one end of the electrode assembly body 110 and the side surface adjacent thereto may be simultaneously impregnated with the binder solution 200.

In an implementation, in relation to the depth or angle at which the electrode assembly body 110 is dipped into or impregnated with the binder solution 200, the negative electrode plate 111, the positive electrode plate 112, and the separator 113 may be dipped or impregnated to such an extent that the binder solution 200, at least located outermost, may be applied thereto, respectively.

In an implementation, the electrode assembly body 110 may be dipped so that the binder solution 200 is applied only to the edge of the end surface of the one end of the electrode assembly body 110 and is not applied to the central portion of the end surface of the one end of the electrode assembly body 110.

After the second dipping step (S4), if there is a region of the edge of the one end of the electrode assembly body where the binder solution has not been applied, an additional dipping step of dipping and impregnating the region with the binder solution may be further included so that the binder solution 200 is entirely applied along the entire edge of the one end of the electrode assembly body 110.

In an implementation, if one straight section of the lower edge of the electrode assembly body 110 is impregnated with the binder solution 200 in the first dipping step (S3) and one curved section of the lower edge of the electrode assembly body 110 is impregnated with the binder solution 200 in the second dipping step (S4), a third dipping step of impregnating the opposite straight section of the lower edge of the electrode assembly body 110 with the binder solution 200, and a fourth dipping step of impregnating the opposite curved section of the lower edge of the electrode assembly body 110 with the binder solution 200, may be further performed.

Like in the first and second dipping steps (S4), in these additional dipping steps, by tilting the electrode assembly body 110 with respect to the surface of the binder solution 200, the end surface of the one end of the electrode assembly body 110 and the side surface adjacent thereto may be simultaneously impregnated with the binder solution 200.

In an implementation, in relation to the depth or angle at which the electrode assembly body 110 is dipped into or impregnated with the binder solution 200, the negative electrode plate 111, the positive electrode plate 112, and the separator 113, at least located outermost, may be dipped to such an extent that the binder solution 200 may be applied thereto, respectively.

In an implementation, the electrode assembly body 110 may be dipped so that the binder solution 200 is applied only to the edge of the end surface of one end of the electrode assembly body 110 and not to the central portion of the end surface of the one end of the electrode assembly body 110.

In an implementation, in the drying step (S5), the binder solution 200 applied to the electrode assembly body 110 is dried.

The drying step (S5) may include a suitable drying that properly dries the binder solution 200, and may include, e.g., UV treatment, depending on the type of the binder solution 200.

FIG. 7 is a schematic diagram of an electrode assembly 100 manufactured by the method for manufacturing an electrode assembly according to an embodiment of the present disclosure.

Referring to FIG. 7, in the electrode assembly 100 manufactured by the electrode assembly manufacturing method according to the embodiment of the present disclosure, a binder 120 may be applied or extend as a whole along the edge of the one end of the electrode assembly body 110. In an implementation, the separator 113 may be at an edge portion using the binder 120 and, e.g., in case of a fall or a drop, it is possible to help prevent a short circuit between the negative electrode plate 111 and the positive electrode plate 112 from occurring due to impacts when the separator 113 is rolled at the edge portion.

In an implementation, as described above, as a result of simultaneously impregnating the end surface and the side surface of the one end of the electrode assembly body 110 in the binder solution 200 in the dipping steps (S3 and S4), the binder 120 may be continuously and integrally applied over the end surface and the side surface of the one end of the electrode assembly body 110, e.g., in an ‘L’ shape. In addition, the length, thickness, or amount of the binder 120 applied to the separator 113, the positive electrode plate 112, the negative electrode plate 111, or the like may be longest or greatest at an outermost part of the electrode assembly and may be gradually shortened or reduced toward the interior of the electrode assembly body 110.

In an implementation, as described above, by impregnating the negative electrode plate 111, the positive electrode plate 112, and the separator 113, at least located outermost, to such an extent that the binder solution 200 is applied thereto, respectively, not only the separator 113 but also the negative electrode plate 111 and the positive electrode plate 112 may be fixed together. Therefore, the electrode assembly 100 may be further protected from impacts.

In an implementation, as described above, by impregnating the electrode assembly body 110 so that the binder solution 200 is applied only to the edge of the end surface of the one end of the electrode assembly body 110 and is not applied to the central portion of the end surface of the one end of the electrode assembly body 110, an electrolyte may be effectively moistened or impregnated through the central portion of the electrode assembly body 110.

By way of summation and review, in a case of a fall or a drop, an inappropriate deformation could occur in a relatively weak edge due to impacts, e.g., the separator may be rolled up, and thus, a short circuit between the negative electrode plate and the positive electrode plate could occur.

As described above, an embodiment of the present disclosure may provide a method for manufacturing an electrode assembly capable of easily applying a binder to an edge portion through a dipping process.

In addition, by fixing a separator at an edge portion by using a binder, an electrode assembly may be provided, which is capable of reducing or preventing inappropriate deformation occurring at the edge portion due to impacts, in case of falling or dropping.

One or more embodiments may provide a method for manufacturing an electrode assembly to which an impact protector for the electrode assembly may be easily applied.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for manufacturing an electrode assembly, the method comprising:
preparing an electrode assembly body;
preparing a binder solution in a storage tank;
impregnating a first region of one end of the electrode assembly body with the binder solution; and
drying the binder solution applied to the electrode assembly body.

2. The method as claimed in claim 1, further comprising impregnating a second region of the one end of the electrode assembly body with the binder solution after impregnating the first region of the one end of the electrode assembly body with the binder solution.

3. The method as claimed in claim 2, further comprising an additional dipping step of impregnating the one end of the electrode assembly body with the binder solution after impregnating the second region if there is another region of the one end of the electrode assembly body where the binder solution has not been applied.

4. The method as claimed in claim 1, wherein impregnating the first region of the one end of the electrode assembly body with the binder solution includes tilting the electrode assembly body with respect to a surface of the binder solution.

5. The method as claimed in claim 1, wherein impregnating the first region of the one end of the electrode assembly body with the binder solution includes simultaneously applying the binder solution to an end surface of the one end of the electrode assembly body and a side surface of the one end of the electrode assembly body that is adjacent to the end surface of the one end of the electrode assembly body.

6. The method as claimed in claim 1, wherein:
the electrode assembly body includes a negative electrode plate, a positive electrode plate, and a separator, and
impregnating the first region of the one end of the electrode assembly body with the binder solution includes applying the binder solution to at least respective outermost layers of the negative electrode plate, the positive electrode plate, and the separator.

7. The method as claimed in claim 1, wherein impregnating the first region of the one end of the electrode assembly body with the binder solution includes applying the binder solution only to an outer edge of the one end of the electrode assembly body, and not applying the binder solution to a central portion of the one end of the electrode assembly body.

8. An electrode assembly, comprising:
a negative electrode plate;
a positive electrode plate;
a separator; and
a binder layer, the binder layer being along an edge of one end of the electrode assembly.

9. The electrode assembly as claimed in claim 8, wherein the binder layer extends as a whole along the edge of the one end.

10. The electrode assembly as claimed in claim 8, wherein the binder layer continuously or integrally extends across an end surface of the one end and a side surface adjacent to the end surface of the one end.

11. The electrode assembly as claimed in claim 8, wherein a thickness of the binder layer on the negative electrode plate, the positive electrode plate, and the separator, is greatest at an outermost part of the electrode assembly and is gradually reduced toward an interior of the electrode assembly.

12. The electrode assembly as claimed in claim 8, wherein the binder layer is on at least respective outermost layers of the negative electrode plate, the positive electrode plate, and the separator.

13. The electrode assembly as claimed in claim 8, wherein the binder layer is only on an outer edge of an end surface of the one end, and is not on a central portion of the end surface of the one end.
